(19) United States
(12) Patent Application Publication
(10) Pub. No.: US 2022/0369143 A1
(43) Pub. Date: Nov. 17, 2022

(54) MANAGEMENT OF MULTIPLE MEASUREMENT GAP

(71) Applicant: LG ELECTRONICS INC., Seoul (KR)

(72) Inventors: Yoonoh YANG, Seoul (KR); Sangwook LEE, Seoul (KR); Suhwan LIM, Seoul (KR); Jaehyuk JANG, Seoul (KR); Jinyup HWANG, Seoul (KR); Jinwoong PARK, Seoul (KR)

(21) Appl. No.: 17/741,208

(22) Filed: May 10, 2022

(30) Foreign Application Priority Data
May 11, 2021 (KR) 10-2021-0060413
Oct. 22, 2021 (KR) 10-2021-0142053

(51) Int. Cl. H04W 24/10; H04W 24/08

(52) U.S. Cl. CPC H04W 24/10; H04W 24/08

(57) ABSTRACT

A disclosure of this specification provides a method for performing measurement, by performed a UE (User Equipment), comprising: receiving priority information from a base station, wherein the priority information includes each priority of MGs (Measurement Gaps); performing measurement with one among the MGs, based on the priority information, wherein the one among the MGs is overlapped with the other MGs in time domain, wherein the one among the MGs has higher priority than the other MGs.

### CROSS-REFERENCE TO RELATED APPLICATIONS

Pursuant to 35 U.S.C. § 119(a), this application claims the benefit of Korean Patent Applications No. 10-2021-0060413 filed on May 11, 2021 and No. 10-2021-0142053 filed on Oct. 22, 2021 the contents of which are all hereby incorporated by reference herein in their entirety.

### BACKGROUND OF THE DISCLOSURE

### Field of the Disclosure

The present disclosure relates to mobile communication.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

When multiple MGs (measurement gaps) are overlapped in the time axis, there is a problem of which MG to use between the network and the UE.

### SUMMARY OF THE DISCLOSURE

In accordance with an embodiment of the present disclosure, a disclosure of this specification provides a method for performing measurement, by performed by a UE (User Equipment), comprising: receiving priority information from a base station, wherein the priority information includes each priority of MGs (Measurement Gaps); performing measurement with one among the MGs, based on the priority information, wherein the one among the MGs is overlapped with the other MGs in time domain, wherein the one among the MGs has higher priority than the other MGs.

The present disclosure can have various advantageous effects.

For example, by configuring priorities of MGs, in cased MGs are overlapped, UE can select one of the MGs and perform measurement with the one.

Advantageous effects obtained through specific examples of the present specification are not limited to the effects listed above. For example, there may be a variety of technical effects that a person having ordinary skill in the related art can understand or derive from this specification. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows an example of UE to which implementations of the present disclosure is applied.

FIG. 5 is a wireless communication system.

FIGS. 6a to 6c are exemplary diagrams illustrating exemplary architectures for next-generation mobile communication services.

FIG. 7 illustrates a structure of a radio frame used in NR.

FIG. 8 shows an example of subframe type in NR.

FIG. 9 shows overlapping types of multiple MGs.

FIG. 10 shows interrupted slots for X1=0 ms for Synchronization scenarios.

FIG. 11 shows interrupted slots for X1=0.5 ms for Synchronization scenarios.

FIG. 12 shows interrupted slots for X1=1 ms for Synchronization scenarios.

FIG. 13 shows interrupted slots for X1=0 ms for Asynchronization scenarios.

FIG. 14 shows interrupted slots for X1=0.5 ms for Asynchronization scenarios.

FIG. 15 shows interrupted slots for X1=1 ms for Asynchronization scenarios.

FIG. 16 shows overlapping MGs with different/same priority.

FIG. 17 shows measurement of overlapped MGs with different priority.

FIG. 18 shows a procedure of UE according to the disclosure of the present specification.

### DESCRIPTION OF EXEMPLARY EMBODIMENTS

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

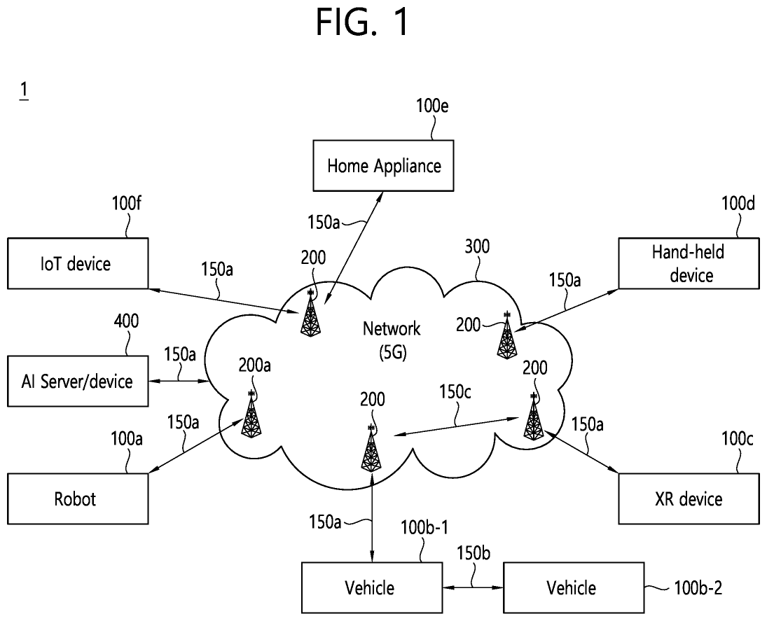

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

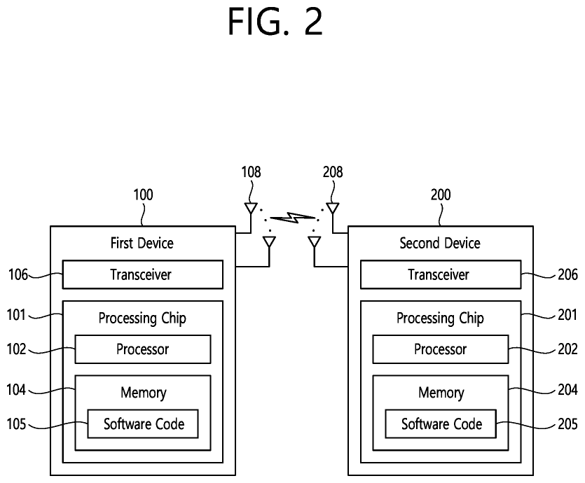

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

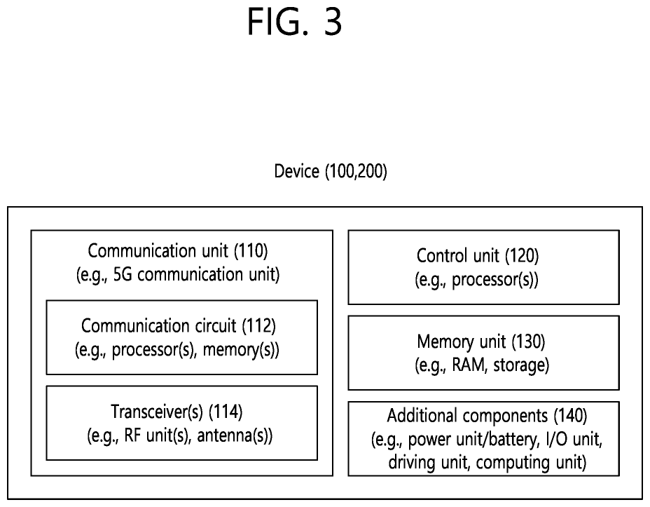

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

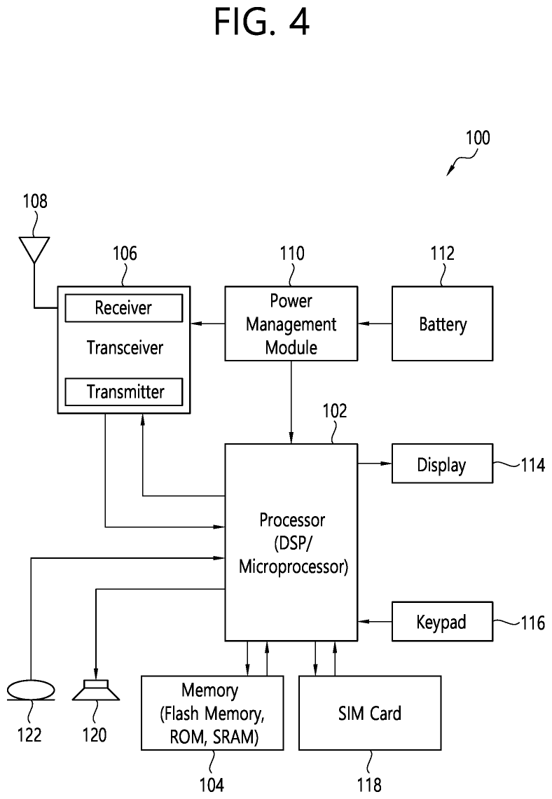

FIG. 4 shows an example of UE to which implementations of the present disclosure is applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 110, a battery 112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 116 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

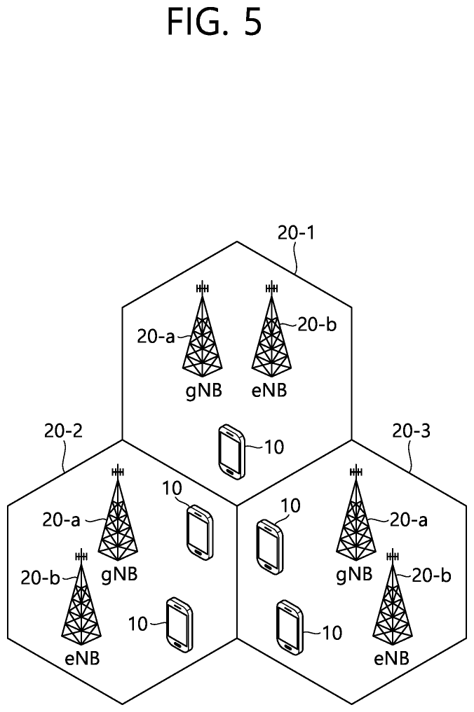

FIG. 5 is an example of a wireless communication system.

As can be seen with reference to FIG. 5, a wireless communication system includes at least one base station (BS). The BS is divided into a gNodeB (or gNB) 20a and an eNodeB (or an eNB) 20b. The gNB 20a supports 5G mobile communication. The eNB 20b supports 4G mobile communication, that is, long term evolution (LTE).

Each base station 20a and 20b provides a communication service for a specific geographic area (generally referred to as a cell) (20-1, 20-2, and 20-3). A cell may be again divided into a plurality of regions (referred to as sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

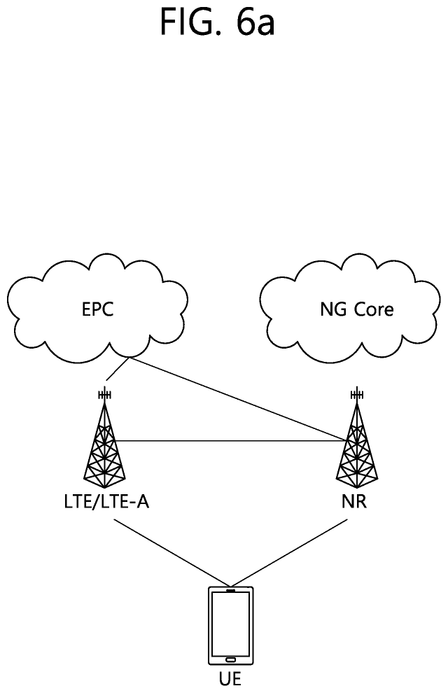

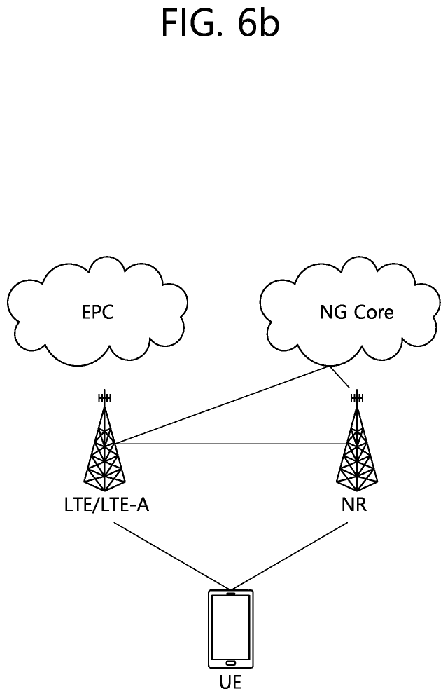

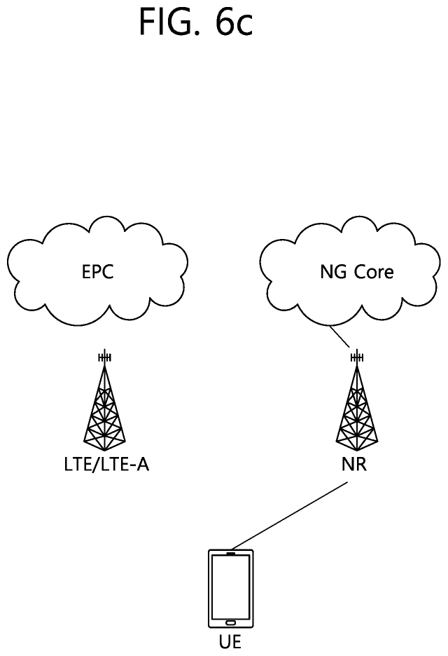

FIGS. 6a to 6c are exemplary diagrams illustrating exemplary architectures for next-generation mobile communication services.

Referring to FIG. 6a, the UE is connected to the LTE/LTE-A-based cell and the NR-based cell in a DC (dual connectivity) manner.

The NR-based cell is connected to a core network for the existing 4G mobile communication, that is, an Evolved Packet Core (EPC).

Referring to FIG. 6b, unlike FIG. 6a, an LTE/LTE-A-based cell is connected to a core network for 5G mobile communication, that is, a Next Generation (NG) core network.

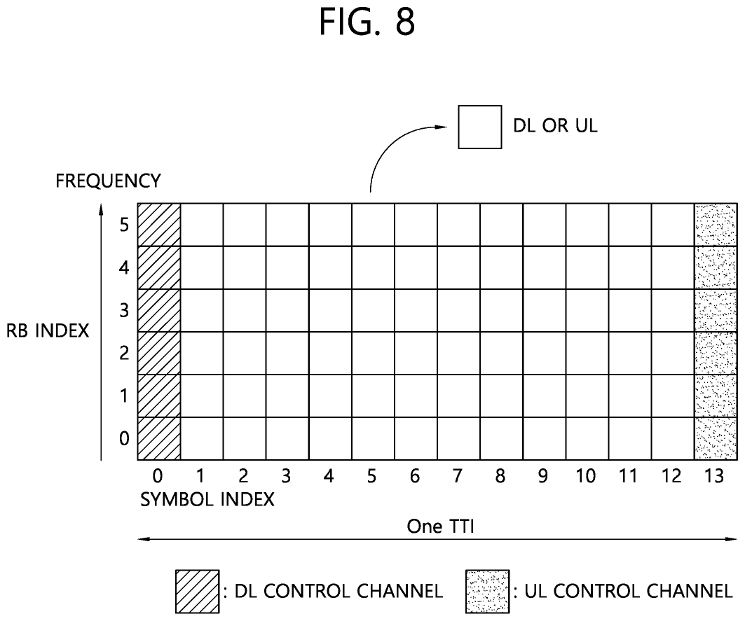

A service method based on the architecture shown in FIGS. 8a and 8b is referred to as a non-standalone (NSA).

Referring to FIG. 6c, the UE is connected only to an NR-based cell. A service method based on this architecture is called standalone (SA).

Meanwhile, in the NR, it may be considered that reception from a base station uses a downlink subframe, and transmission to a base station uses an uplink subframe. This method can be applied to paired and unpaired spectra. A pair of spectrum means that two carrier spectrums are included for downlink and uplink operation. For example, in a paired spectrum, one carrier may include a downlink band and an uplink band that are paired with each other.

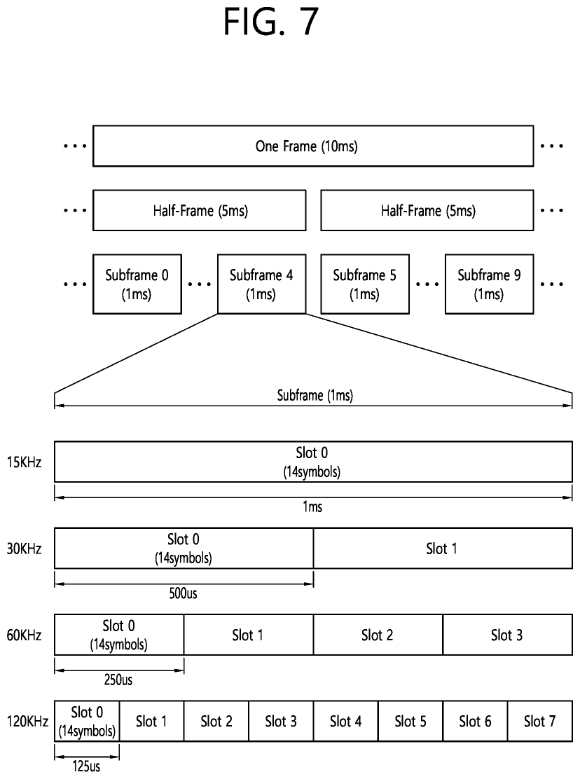

FIG. 7 illustrates a structure of a radio frame used in NR.

In NR, uplink and downlink transmission are composed of frames. The radio frame may have a length of 10 ms and may be defined as two 5-ms half-frames (HFs). Each half-frame may be defined as five 1-ms subframes (SFs). A subframe may be divided into one or more slots, and the number of slots in a subframe may depend on SCS (Subcarrier Spacing). Each slot may include 12 or 14 OFDM(A) symbols according to a cyclic prefix (CP). In some implementations, if a CP is used, then each slot contains 14 symbols. If an extended CP is used, then each slot contains 12 symbols. The symbol may include, for example, an OFDM symbol (or a CP-OFDM symbol) and an SC-FDMA symbol (or a DFT-s-OFDM symbol.

FIG. 8 shows an example of subframe type in NR.

A transmission time interval (TTI) shown in FIG. 8 may be called a subframe or slot for NR (or new RAT). The subframe (or slot) in FIG. 8 may be used in a TDD system of NR (or new RAT) to minimize data transmission delay. As shown in FIG. 8, a subframe (or slot) includes 14 symbols as does the current subframe. A front symbol of the subframe (or slot) can be used for a downlink control channel, and a rear symbol of the subframe (or slot) can be used for a uplink control channel. Other channels can be used for downlink data transmission or uplink data transmission. According to such structure of a subframe (or slot), downlink transmission and uplink transmission may be performed sequentially in one subframe (or slot). Therefore, a downlink data may be received in the subframe (or slot), and a uplink acknowledge response (ACK/NACK) may be transmitted in the subframe (or slot).

A subframe (or slot) in this structure may be called a self-constrained subframe.

Specifically, first N symbols in a slot may be used to transmit a DL control channel (hereinafter, DL control region), and last M symbols in a slot may be used to transmit a UL control channel (hereinafter, UL control region). N and M are each an integer greater than or equal to 0. A resource region (hereinafter, referred to as a data region) between the DL control region and the UL control region can be used for DL data transmission or for UL data transmission. For example, a PDCCH may be transmitted in the DL control region and the PDSCH may be transmitted in the DL data region. A PUCCH may be transmitted in the UL control region, and a PUSCH may be transmitted in the UL data region.

If this structure of a subframe (or slot) is used, it may reduce time required to retransmit data regarding which a reception error occurred, and thus, a final data transmission waiting time may be minimized In such structure of the self-contained subframe (slot), a time gap may be required for transition from a transmission mode to a reception mode or vice versa. To this end, when downlink is transitioned to uplink in the subframe structure, some OFDM symbols may be set as a Guard Period (GP).

<Support of Various Numerology>

In a next system, a plurality of numerologies may be provided to a terminal according to the development of wireless communication technology. For example, when SCS is 15 kHz, it supports a wide area in traditional cellular bands, and when SCS is 30 kHz/60 kHz, it supports a dense-urban, lower latency and wider carrier bandwidth, and when SCS is 60 kHz or higher, it supports a bandwidth greater than 24.25 GHz to overcome phase noise.

The numerology may be defined by a cycle prefix (CP) length and a subcarrier spacing (SCS). One cell may provide a plurality of numerologies to the terminal. When an index of numerology is expressed as μ, an interval of each subcarrier and a corresponding CP length may be as shown in the table below.

TABLE 3

| μ | Δf = 2^{μ} · 15 [kHz] | CP |
|---|---|---|
| 0 | 15 | normal |
| 1 | 30 | normal |
| 2 | 60 | normal, extended |
| 3 | 120 | normal |
| 4 | 240 | normal |

In the case of normal CP, when an index of numerology is expressed as μ, the number (N^{slot}_{symb}) of OFDM symbols per slot, the number of slots (N^{frame,μ}ₛₗₒₜ) per frame, and the number (N^{subframe,μ}ₛₗₒₜ) of slots per subframe are shown in the table below.

TABLE 4

| μ | N^{slot}_{symb} | N^{frame, μ}ₛₗₒₜ | N^{subframe, μ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the case of extended CP, when the index of numerology is expressed as μ, the number (N^{slot}_{symb}) of OFDM symbols per slot, the number (N^{frame,μ}ₛₗₒₜ) of slots per frame, and the number (N^{subframe,μ}ₛₗₒₜ) of slots per subframe are shown in the table below.

TABLE 5

| μ | N^{slot}_{symb} | N^{frame, μ}ₛₗₒₜ | N^{subframe, μ}ₛₗₒₜ |
|---|---|---|---|
| 2 | 12 | 40 | 4 |

<Measurement Gap>

If the UE requires measurement gaps to identify and measure intra-frequency cells and/or inter-frequency cells and/or inter-RAT E-UTRAN cells, and the UE does not support independent measurement gap patterns for different frequency ranges as specified, in order for the requirements in the following clauses to apply the network must provide a single per-UE measurement gap pattern for concurrent monitoring of all frequency layers.

If the UE requires measurement gaps to identify and measure intra-frequency cells and/or inter-frequency cells and/or inter-RAT E-UTRAN cells, and the UE supports independent measurement gap patterns for different frequency ranges as specified, in order for the requirements to apply the network must provide either per-FR measurement gap patterns for frequency range where UE requires per-FR measurement gap for concurrent monitoring of all frequency layers of each frequency range independently, or a single per-UE measurement gap pattern for concurrent monitoring of all frequency layers of all frequency ranges.

If the UE is configured to measure PRS for any RSTD, PRS-RSRP, and UE Rx-Tx time difference measurement, in order for the requirements, the network must provide
a single per-UE measurement gap pattern for concurrent monitoring of all positioning frequency layers and intra-frequency, inter-frequency and/or inter-RAT frequency layers of all frequency ranges, or
for measurement gap patterns other than #24 and #25, if UE supports independent measurement gap patterns for different frequency ranges, per-FR measurement gap pattern for the frequency range for concurrent monitoring of all positioning frequency layers and intra-frequency, inter-frequency cells and/or inter-RAT frequency layers in the corresponding frequency range.

During the per-UE measurement gaps the UE:
is not required to conduct reception/transmission from/to the corresponding E-UTRAN PCell, E-UTRAN SCell(s) and NR serving cells for E-UTRA-NR dual connectivity except the reception of signals used for RRM measurement(s) and the signals used for random access procedure.
is not required to conduct reception/transmission from/to the corresponding NR serving cells for SA (with single carrier or CA configured) except the reception of signals used for RRM measurement(s), PRS measurement(s) and the signals used for random access procedure.
is not required to conduct reception/transmission from/to the corresponding PCell, SCell(s) and E-UTRAN serving cells for NR-E-UTRA dual connectivity except the reception of signals used for RRM measurement(s), PRS measurement(s) and the signals used for random access procedure.
is not required to conduct reception/transmission from/to the corresponding NR serving cells for NR-DC except the reception of signals used for RRM measurement(s), PRS measurement(s) and the signals used for random access procedure.

During the per-FR measurement gaps the UE:
is not required to conduct reception/transmission from/to the corresponding E-UTRAN PCell, E-UTRAN SCell(s) and NR serving cells in the corresponding frequency range for E-UTRA-NR dual connectivity except the reception of signals used for RRM measurement(s) and the signals used for random access procedure.
is not required to conduct reception/transmission from/to the corresponding NR serving cells in the corresponding frequency range for SA (with single carrier or CA configured) except the reception of signals used for RRM measurement(s), PRS measurement(s) and the signals used for random access procedure.
is not required to conduct reception/transmission from/to the corresponding PCell, SCell(s) and E-UTRAN serving cells in the corresponding frequency range for NR-E-UTRA dual connectivity except the reception of signals used for RRM measurement(s), PRS measurement(s) and the signals used for random access procedure.
is not required to conduct reception/transmission from/to the corresponding NR serving cells in the corresponding frequency range for NR-DC except the reception of signals used for RRM measurement(s), PRS measurement(s) and the signals used for random access procedure.

1. Measurement Gap Configuration

If gapFR1 is set to setup, if an FR1 measurement gap configuration is already setup, the UE shall release the FR1 measurement gap configuration.

If gapFR1 is set to setup, the UE shall setup the FR1 measurement gap configuration indicated by the measGapConfig in accordance with the received gapOffset, i.e., the first subframe of each gap occurs at an SFN and subframe meeting the following condition:
SFN mod T=FLOOR(gapOffset/10);
subframe=gapOffset mod 10;
with T=MGRP/10;

If gapFR1 is set to setup, the UE shall apply the specified timing advance mgta to the gap occurrences calculated above (i.e. the UE starts the measurement mgta ms before the gap subframe occurrences).

If gapFR1 is set to release, the UE shall release the FR1 measurement gap configuration.

If gapFR2 is set to setup, if an FR2 measurement gap configuration is already setup, the UE shall release the FR2 measurement gap configuration

If gapFR2 is set to setup, the UE shall setup the FR2 measurement gap configuration indicated by the measGapConfig in accordance with the received gapOffset, i.e., the first subframe of each gap occurs at an SFN and subframe meeting the following condition:
SFN mod T=FLOOR(gapOffset/10);
subframe=gapOffset mod 10;
with T=MGRP/10

If gapFR2 is set to setup, the UE shall apply the specified timing advance mgta to the gap occurrences calculated above (i.e. the UE starts the measurement mgta ms before the gap subframe occurrences).

If gapFR2 is set to release, the UE shall release the FR2 measurement gap configuration.

If gapUE is set to setup, if a per UE measurement gap configuration is already setup, the UE shall release the per UE measurement gap configuration.

If gapUE is set to setup, the UE shall setup the per UE measurement gap configuration indicated by the measGapConfig in accordance with the received gapOffset, i.e., the first subframe of each gap occurs at an SFN and subframe meeting the following condition:
SFN mod T=FLOOR(gapOffset/10);
subframe=gapOffset mod 10;
with T=MGRP/10

If gapUE is set to setup, the UE shall apply the specified timing advance mgta to the gap occurrences calculated above (i.e. the UE starts the measurement mgta ms before the gap subframe occurrences).

If gapUE is set to release release the per UE measurement gap configuration.

For gapFR2 configuration with synchronous CA, for the UE in NE-DC or NR-DC, the SFN and subframe of the serving cell indicated by the refServCellIndicator in gapFR2 is used in the gap calculation. Otherwise, the SFN and subframe of a serving cell on FR2 frequency is used in the gap calculation.

For gapFR1 or gapUE configuration, for the UE in NE-DC or NR-DC, the SFN and subframe of the serving cell indicated by the refServCellIndicator in corresponding gapFR1 or gapUE is used in the gap calculation. Otherwise, the SFN and subframe of the PCell is used in the gap calculation.

For gapFR2 configuration with asynchronous CA, for the UE in NE-DC or NR-DC, the SFN and subframe of the serving cell indicated by the refServCellIndicator and refFR2ServCellAsyncCA in gapFR2 is used in the gap calculation. Otherwise, the SFN and subframe of a serving cell on FR2 frequency indicated by the refFR2ServCellAsyncCA in gapFR2 is used in the gap calculation.

(1) MeasGapConfig

The IE MeasGapConfig specifies the measurement gap configuration and controls setup/release of measurement gaps.

Table 6 shows MeasGapConfig information element

TABLE 6
MeasGapConfig
information element

| | | | |
|---|---|---|---|
| MeasGapConfig | gapFR2 | SetupRelease | optional |
| | | {GapConfig} | |
| | gapFR1 | SetupRelease | OPTIONAL |
| | | {GapConfig} | |
| | gapUE | SetupRelease | OPTIONAL |
| | | {GapConfig} | |
| GapConfig. | gapOffset | INTEGER (0 . . . 159) | |
| | mgl | ENUMERATED | |
| | | {ms1dot5, ms3, | |
| | | ms3dot5, ms4, | |
| | | ms5dot5, ms6} | |
| | mgrp | ENUMERATED | |
| | | {ms20, ms40, ms80, | |
| | | ms160} | |
| | mgta | ENUMERATED | |
| | | {ms0, ms0dot25, | |
| | | ms0dot5} | |
| | refServCellIndicator | ENUMERATED | OPTIONAL |
| | | {pCell, pSCell, mcg- | |
| | | FR2} | |
| | refFR2ServCellAsyncCA-r16 | ServCellIndex | OPTIONAL |
| | mgl-r16 | ENUMERATED | OPTIONAL |
| | | {ms10, ms20} | |

Table 7 shows MeasGapConfig field descriptions

TABLE 7
MeasGapConfig field descriptions

gapFR1
Indicates measurement gap configuration that applies to FR1 only. In (NG)EN-DC, gapFR1 cannot
be set up by NR RRC (i.e. only LTE RRC can configure FR1 measurement gap). In NE-DC, gapFR1
can only be set up by NR RRC (i.e. LTE RRC cannot configure FR1 gap). In NR-DC, gapFR1 can
only be set up in the measConfig associated with MCG. gapFR1 can not be configured together with
gapUE.
gapFR2
Indicates measurement gap configuration applies to FR2 only. In (NG)EN-DC or NE-DC, gapFR2
can only be set up by NR RRC (i.e. LTE RRC cannot configure FR2 gap). In NR-DC, gapFR2 can
only be set up in the measConfig associated with MCG. gapFR2 cannot be configured together with
gapUE.
gapUE
Indicates measurement gap configuration that applies to all frequencies (FR1 and FR2). In (NG)EN-
DC, gapUE cannot be set up by NR RRC (i.e. only LTE RRC can configure per UE measurement
gap). In NE-DC, gapUE can only be set up by NR RRC (i.e. LTE RRC cannot configure per UE gap).
In NR-DC, gapUE can only be set up in the measConfig associated with MCG. If gapUE is
configured, then neither gapFR1 nor gapFR2 can be configured.
gapOffset
Value gapOffset is the gap offset of the gap pattern with MGRP indicated in the field mgrp. The value
range is from 0 to mgrp-1.
mgl
Value mgl is the measurement gap length in ms of the measurement gap. Value ms1dot5 corresponds
to 1.5 ms, ms3 corresponds to 3 ms and so on. If mgl-r16 is signalled, UE shall use mgl-r16 (with
suffix) and ignore the mgl (without suffix).
mgrp
Value mgrp is measurement gap repetition period in (ms) of the measurement gap.
mgta
Value mgta is the measurement gap timing advance in ms. Value ms0 corresponds to 0 ms, ms0dot25
corresponds to 0.25 ms and ms0dot5 corresponds to 0.5 ms. For FR2, the network only configures 0
ms and 0.25 ms.
refFR2ServCellIAsyncCA
Indicates the FR2 serving cell identifier whose SFN and subframe is used for FR2 gap calculation
for this gap pattern with asynchronous CA involving FR2 carrier(s).
refServCellIndicator
Indicates the serving cell whose SFN and subframe are used for gap calculation for this gap pattern.
Value pCell corresponds to the PCell, pSCell corresponds to the PSCell, and mcg-FR2 corresponds
to a serving cell on FR2 frequency in MCG.

<Problems to be Solved in the Disclosure of this Specification>

When multiple MGs (measurement gaps) are overlapped in the time axis, there is a problem of which MG to use between the network and the UE.

<Disclosure of the Present Specification>

Currently, in the 3GPP standardization organization, standard discussion is in progress for Rel-17 NR measurement gap (MG) enhancement. When measurement is performed using multiple MGs, the number of interrupted slots generated in the serving cell may be proposed. In addition, when setting up multiple MGs, a method to minimize the performance degradation of the serving cell may be proposed.

Up to Rel-16, the number of interrupted slots for serving cell(s) according to MG configuration was standardized for both synchronization and asynchronization cases in single MG. Referring to this standard, the actual network may be scheduled in consideration of interrupted slots.

When setting Multiple MGs, depending on whether or not overlapping between individual MGs, there may be several types of overlapping as follows.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

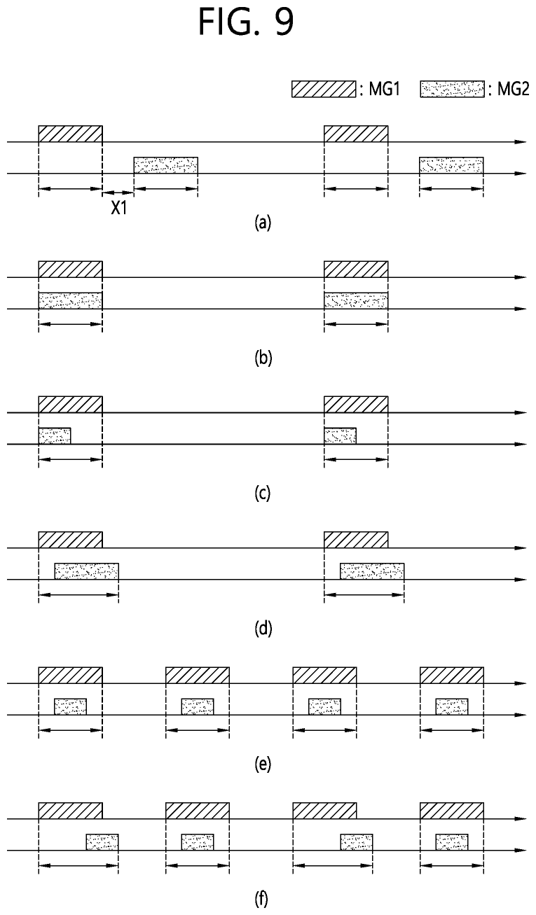

FIG. 9 shows an example of overlapping types of multiple MGs to which implementations of the present disclosure is applied.

FIG. 9 (a) shows fully non-overlapped (FNO). All gap occasions of 2 MGs are disjoint in time.

FIGS. 9 (b) and (c) show fully-overlapped (FO). Every gap occasion of one MG is fully covered by every gap occasion of another MG with the same periodicity.

FIG. 9 (d)-(f) show partially overlapped.

FIG. 9 (d) shows fully-partial overlapped (FPO). Every gap occasion of one MG is partially overlapped by every gap occasion of another MG with the same periodicity.

FIG. 9 (e) shows partially-fully overlapped (PFO). Every gap occasion of one MG is fully covered by gap occasion of another MG with the different periodicity.

FIG. 9 (f) shows partially-partial overlapped (PPO). Every gap occasion of one MG is partially covered by gap occasion of another MG with the different periodicity.

1. Fully Non-Overlapped (FNO)

Total number of interrupted slots can be impacted by MG timing advance(MGTA) and time difference between the end of MG1 and the start of MG2 (X1)

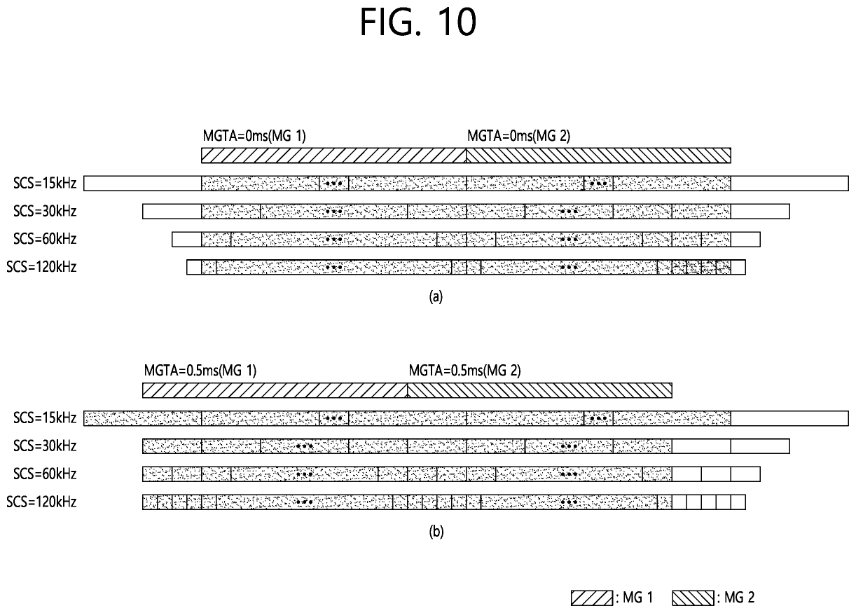

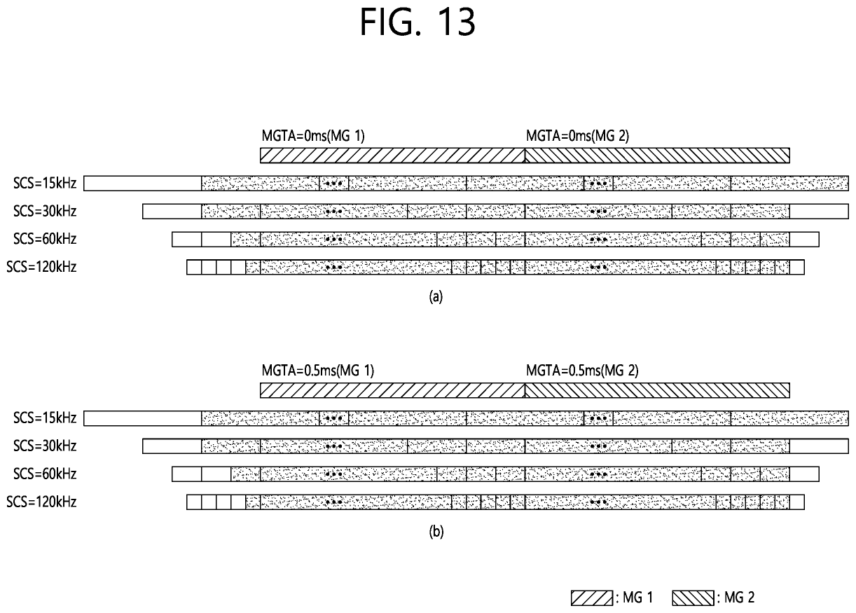

FIGS. 10, 11 and 12 show the interrupted slots by multiple MG patterns with FNO for synchronization scenarios. And, FIGS. 13, 14 and 15 show the interrupted slots by multiple MG patterns with FNO for asynchronization scenarios.

FIG. 10 shows an example of interrupted slots for Synchronization scenarios to which implementations of the present disclosure is applied.

FIG. 10 assumes:
{MGTA_MG1, MGTA_MG2}={0 ms, 0 ms}, {0.5 ms, 0.5 ms}
X1=0 ms

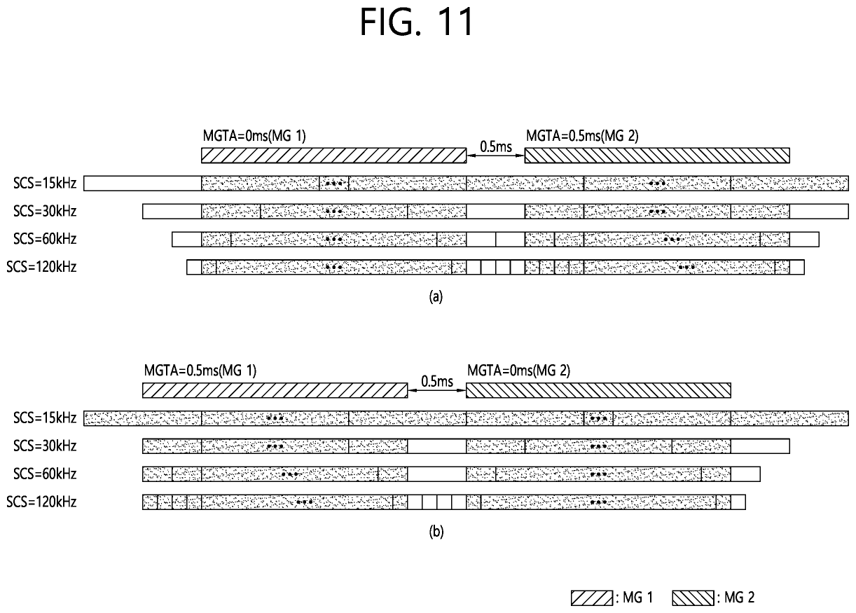

FIG. 11 shows another example of interrupted slots for Synchronization scenarios to which implementations of the present disclosure is applied.

FIG. 11 assumes:
{MGTA_MG1, MGTA_MG2}={0 ms, 0.5 ms}, {0.5 ms, 0 ms}
   X1=0.5 ms

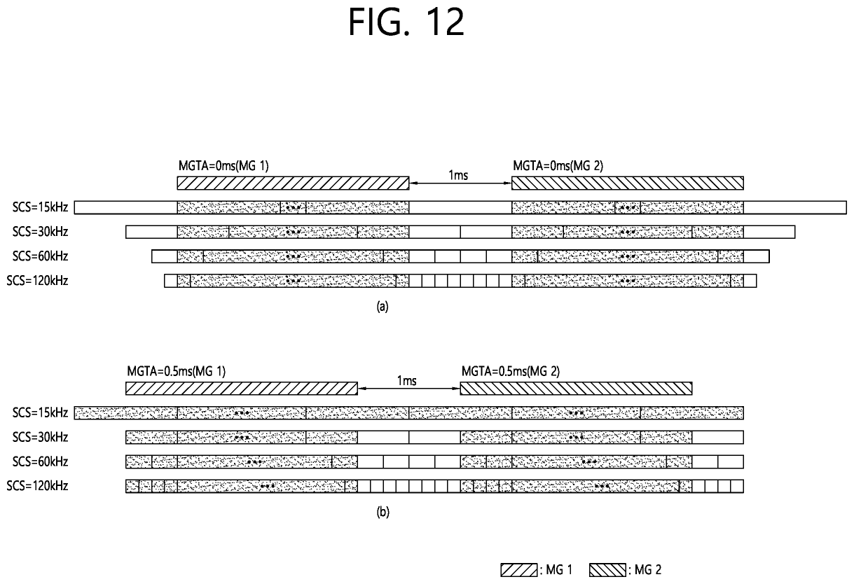

FIG. 12 shows another example of interrupted slots for Synchronization scenarios to which implementations of the present disclosure is applied.

FIG. 12 assumes:
{MGTA_MG1, MGTA_MG2}={0 ms, 0 ms}, {0.5 ms, 0.5 ms}
   X1=1 ms

FIG. 13 shows an example of interrupted slots for Asynchronization scenarios to which implementations of the present disclosure is applied.

FIG. 13 assumes:
{MGTA_MG1, MGTA_MG2}={0 ms, 0 ms}, 10.5 ms, {0.5 ms}
   X1=0 ms

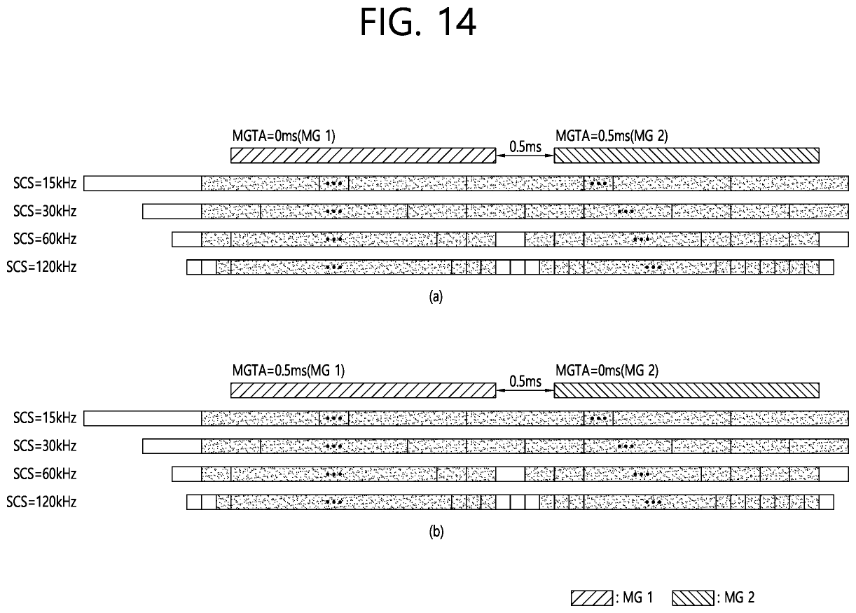

FIG. 14 shows another example of interrupted slots for Asynchronization scenarios to which implementations of the present disclosure is applied.

FIG. 14 assumes:
{MGTA_MG1, MGTA_MG2}={0 ms, 0.5 ms}, {0.5 ms, 0 ms}
   X1=0.5 ms

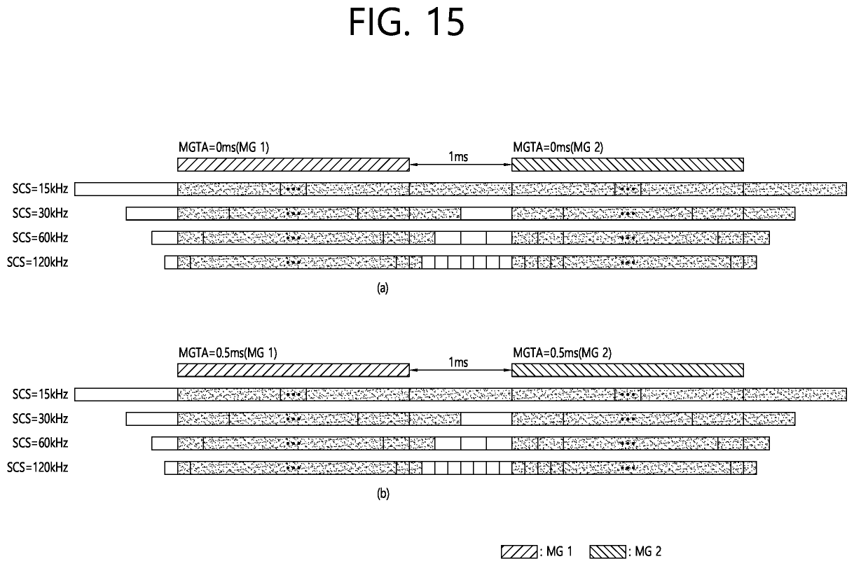

FIG. 15 shows another example of interrupted slots for Asynchronization scenarios to which implementations of the present disclosure is applied.

FIG. 15 assumes:
{MGTA_MG1, MGTA_MG2}={0 ms, 0 ms}, {0.5 ms, 0.5 ms}
   X1=1 ms

Table 8 and Table 9 show the total number of interrupted slots by MG1 and MG1 for Synchronization scenarios and for Asynchronization scenarios respectively.

Table 8 shows total number of interrupted slots by multiple MG patterns for FNO in Synchronization scenarios.

TABLE 8

| Timing | | | | Total number of interrupted | | |
|---|---|---|---|---|---|---|
| difference | | | | slots on serving cell (s) | | |
| btw MG1 | | | NR | MG1 | MG2 | |
| and MG2 | MGTA (ms) | | SCS | (same as | (same as | |
| (X1) (ms) | MG1 | MG2 | (kHz) | Rel-16) | Rel-16) | MG1 + MG2 |
| 0 | 0 | 0 | 15 | Y1 | Z1 | Y1 + Z1 |
| | | | 30 | Y2 | Z2 | Y2 + Z2 |
| | | | 60 | Y3 | Z3 | Y3 + Z3 |
| | | | 120 | Y4 | Z4 | Y4 + Z4 |
| | 0.5 | 0.5 | 15 | Y1 + 1 | Z1 + 1 | Y1 + Z1 + 1 |
| | | | 30 | Y2 | Z2 | Y2 + Z2 |
| | | | 60 | Y3 | Z3 | Y3 + Z3 |
| | | | 120 | Y4 | Z4 | Y4 + Z4 |
| 0.5 | 0 | 0.5 | 15 | Y1 | Z1 + 1 | Y1 + Z1 + 1 |
| | | | 30 | Y2 | Z2 | Y2 + Z2 |
| | | | 60 | Y3 | Z3 | Y3 + Z3 |
| | | | 120 | Y4 | Z4 | Y4 + Z4 |
| | 0.5 | 0 | 15 | Y1 + 1 | Z1 | Y1 + Z1 + 1 |
| | | | 30 | Y2 | Z2 | Y2 + Z2 |
| | | | 60 | Y3 | Z3 | Y3 + Z3 |
| | | | 120 | Y4 | Z4 | Y4 + Z4 |
| 1.0 | 0 | 0 | 15 | Y1 | Z1 | Y1 + Z1 |
| | | | 30 | Y2 | Z2 | Y2 + Z2 |
| | | | 60 | Y3 | Z3 | Y3 + Z3 |
| | | | 120 | Y4 | Z4 | Y4 + Z4 |
| | 0.5 | 0.5 | 15 | Y1 + 1 | Z1 + 1 | Y1 + Z1 + 2 |
| | | | 30 | Y2 | Z2 | Y2 + Z2 |
| | | | 60 | Y3 | Z3 | Y3 + Z3 |
| | | | 120 | Y4 | Z4 | Y4 + Z4 |

Note:
If X1 > 1.0 ms, the total number of interrupted slots on serving cell(s) is same as that of X1 = 1.0 ms.

Table 9 shows total number of interrupted slots by multiple MG patterns for FNO in Asynchronization scenarios.

TABLE 9

| Timing | | | | Total number of interrupted | | |
|---|---|---|---|---|---|---|
| difference | | | | slots on serving cell(s) | | |
| btw MG1 | | | NR | MG1 | MG2 | |
| and MG2 | MGTA (ms) | | SCS | (same as | (same as | |
| (X1) (ms) | MG1 | MG2 | (kHz) | Rel-16) | Rel-16) | MG1 + MG2 |
| 0 | 0 | 0 | 15 | Y1 + 1 | Z1 + 1 | Y1 + Z1 + 1 |
| | | | 30 | Y2 + 1 | Z2 + 1 | Y2 + Z2 + 1 |
| | | | 60 | Y3 + 1 | Z3 + 1 | Y3 + Z3 + 1 |
| | | | 120 | Y4 + 1 | Z4 + 1 | Y4 + Z4 + 1 |
| | 0.5 | 0.5 | 15 | Y1 + 1 | Z1 + 1 | Y1 + Z1 + 1 |
| | | | 30 | Y2 + 1 | Z2 + 1 | Y2 + Z2 + 1 |
| | | | 60 | Y3 + 1 | Z3 + 1 | Y3 + Z3 + 1 |
| | | | 120 | Y4 + 1 | Z4 + 1 | Y4 + Z4 + 1 |
| 0.5 | 0 | 0.5 | 15 | Y1 + 1 | Z1 + 1 | Y1 + Z1 + 1 |
| | | | 30 | Y2 + 1 | Z2 + 1 | Y2 + Z2 + 2 |
| | | | 60 | Y3 + 1 | Z3 + 1 | Y3 + Z3 + 2 |
| | | | 120 | Y4 + 1 | Z4 + 1 | Y4 + Z4 + 2 |
| | 0.5 | 0 | 15 | Y1 + 1 | Z1 + 1 | Y1 + Z1 + 1 |
| | | | 30 | Y2 + 1 | Z2 + 1 | Y2 + Z2 + 2 |
| | | | 60 | Y3 + 1 | Z3 + 1 | Y3 + Z3 + 2 |
| | | | 120 | Y4 + 1 | Z4 + 1 | Y4 + Z4 + 2 |
| 1.0 | 0 | 0 | 15 | Y1 + 1 | Z1 + 1 | Y1 + Z1 + 2 |
| | | | 30 | Y2 + 1 | Z2 + 1 | Y2 + Z2 + 2 |
| | | | 60 | Y3 + 1 | Z3 + 1 | Y3 + Z3 + 2 |
| | | | 120 | Y4 + 1 | Z4 + 1 | Y4 + Z4 + 2 |
| | 0.5 | 0.5 | 15 | Y1 + 1 | Z1 + 1 | Y1 + Z1 + 2 |
| | | | 30 | Y2 + 1 | Z2 + 1 | Y2 + Z2 + 2 |
| | | | 60 | Y3 + 1 | Z3 + 1 | Y3 + Z3 + 2 |
| | | | 120 | Y4 + 1 | Z4 + 1 | Y4 + Z4 + 2 |

Note:
If X1 > 1.0 ms, the total number of interrupted slots on serving cell(s) is same as that of X1 = 1.0 ms.

Here, based on Rel-16, the followings are assumed.

Y1/Y2/Y3/Y4 may be total number of interrupted slots by MG1 for SCS of 15 kHz, 30 kHz, 60 kHz and 120 kHz respectively.

Z1/Z2/Z3/Z4 may be total number of interrupted slots by MG2 for SCS of 15 kHz, 30 kHz, 60 kHz and 120 kHz respectively.

Y1/Y2/Y3/Y4 and Z1/Z2/Z3/Z4 may be assumed to be values for each MGL with MGTA of 0 ms in Table 10.

Table 10 shows Total number of interrupted slots on all serving cells during MGL for Synchronous EN-DC, NR standalone operation (with single carrier, NR CA and synchronous NR-DC configuration) and NE-DC, and on all serving cells in MCG for NR standalone operation (with asynchronous NR-DC configuration) with per-UE measurement gap or per-FR measurement gap for FR1.

TABLE 10

| | Total number of interrupted slots on serving cells | | | | | | | | | |
|---|---|---|---|---|---|---|---|---|---|---|
| | | | | | | When MG timing advance | | | | |
| | When MG timing advance of 0 ms is applied | | | | | of 0.5 ms is applied | | | | |
| RCS | GL = | GL = | GL = | GL = | GL = | GL = | GL = | GL = | GL = | GL = |
| kHz) | 20 ms | 10 ms | 6 ms | 4 ms | 3 ms | 20 ms | 10 ms | 6 ms | 4 ms | 3 ms |
| 5 | 0 | 0 | | | | 1Note | 1Note | Note | Note | Note |
| | | | | | | 3 | 3 | 3 | 3 | 3 |
| 0 | 0 | 0 | 2 | | | 0 | 0 | 2 | | |
| 0 | 0 | 0 | 4 | 6 | 2 | 0 | 0 | 4 | 6 | 2 |
| 20 | 60 | 0 | 8 | 2 | 4 | 60 | 0 | 8 | 2 | 4 |

NOTE 1:
For Gap Pattern ID 0, 1, 2 and 3, total number of interrupted subframes on MCG is MGL subframes when MG timing advance of 0 ms is applied, and (MGL + 1) subframes when MG timing advance of 0.5 ms is applied.
NOTE 2:
NR SCS of 120 kHz is only applicable to the case with per-UE measurement gap.
NOTE 3:
Non-overlapped half-slots occur before and after the measurement gap. Whether a Rel-15 UE can receive and/or transmit in those half-slots is up to UE implementation.

Total number of interrupted slots on serving cell(s) due to two multiple MG patterns with FNO with values in Table 9 for Synchronization scenarios may be specified.

Total number of interrupted slots on serving cell(s) due to two multiple MG patterns with FNO with values in Table 10 for Asynchronization scenarios may be specified.

Table 11 shows total number of interrupted slots on all serving cells during MGL for Synchronous EN-DC, NR standalone operation (with single carrier, NR CA and synchronous NR-DC configuration) and NE-DC, and on all serving cells in MCG for NR standalone operation (with asynchronous NR-DC configuration) with per-UE measurement gap or per-FR measurement gap for FR1.

TABLE 11

| | Total number of interrupted slots on serving cells | | | | | | | | | |
|---|---|---|---|---|---|---|---|---|---|---|
| | When MG timing advance | | | | | When MG timing advance | | | | |
| NR | of 0 ms is applied | | | | | of 0.5 ms is applied | | | | |
| SCS | MGL = | MGL = | MGL = | MGL = | MGL = | MGL = | MGL = | MGL = | MGL = | MGL = |
| (kHz) | 20 ms | 10 ms | 6 ms | 4 ms | 3 ms | 20 ms | 10 ms | 6 ms | 4 ms | 3 ms |
| 15 | 20 | 10 | 6 | 4 | 3 | 21^{Note3} | 11^{Note3} | 7^{Note3} | 5^{Note3} | 4^{Note3} |
| 30 | 40 | 20 | 12 | 8 | 6 | 40 | 20 | 12 | 8 | 6 |
| 60 | 80 | 40 | 24 | 16 | 12 | 80 | 40 | 24 | 16 | 12 |
| 120 | 160 | 80 | 48 | 32 | 24 | 160 | 80 | 48 | 32 | 24 |

NOTE 1:
For Gap Pattern ID 0, 1, 2 and 3, total number of interrupted subframes on MCG is MGL subframes when MG timing advance of 0 ms is applied, and (MGL + 1) subframes when MG timing advance of 0.5 ms is applied.
NOTE 2:
NR SCS of 120 kHz is only applicable to the case with per-UE measurement gap.
^{NOTE 3}:
Non-overlapped half-slots occur before and after the measurement gap. Whether a Rel-15 UE can receive and/or transmit in those half-slots is up to UE implementation.

The number of interrupted slots set in Table 11 may be applied to MG1 MGL and MG2 MGL, respectively. However, if i) X1=0 & MG1's MGTA=0 & MG2's MGTA=0, ii) X1=0.5 ms & MG1's MGTA=0 and MG2's MGTA=0.5 ms or iii) X1=0.5 ms & MG1's MGTA=0.5 ms and MG2's MGTA=0, the total sum of interrupted slots by MG1 MGL and MG2 MGL may be 1 slot smaller than the sum of individual interrupted slots.

Table 12 shows total number of interrupted slots on serving cells during MGL for Asynchronous EN-DC, and on all serving cells in SCG for NR standalone operation (with asynchronous NR-DC configuration) with per-UE measurement gap or per-FR measurement gap for FR1.

TABLE 12

| | Total number of interrupted slots on serving cells | | | | | | | | | |
|---|---|---|---|---|---|---|---|---|---|---|
| | When MG timing advance | | | | | When MG timing advance | | | | |
| NR | of 0 ms is applied | | | | | of 0.5 ms is applied | | | | |
| SCS | MGL = | MGL = | MGL = | MGL = | MGL = | MGL = | MGL = | MGL = | MGL = | MGL = |
| (kHz) | 20 ms | 10 ms | 6 ms | 4 ms | 3 ms | 20 ms | 10 ms | 6 ms | 4 ms | 3 ms |
| 15 | 21 | 11 | 7 | 5 | 4 | 21 | 11 | 7 | 5 | 4 |
| 30 | 41 | 21 | 13 | 9 | 7 | 41 | 21 | 13 | 9 | 7 |
| 60 | 81 | 41 | 25 | 17 | 13 | 81 | 41 | 25 | 17 | 13 |
| 120 | 161 | 81 | 49 | 33 | 25 | 161 | 81 | 49 | 33 | 25 |

NOTE 1:
For Gap Pattern ID 0, 1, 2 and 3, total number of interrupted subframes on MCG is MGL subframes when MG timing advance of 0 ms is applied, and (MGL + 1) subframes when MG timing advance of 0.5 ms is applied.
NOTE 2:
NR SCS of 120 kHz is only applicable to the case with per-UE measurement gap.

The number of interrupted slots set in Table 9.1.2-4a may be applied to MG1 MGL and MG2 MGL, respectively. However, if i) X1=0 & MG1's MGTA=0 & MG2's MGTA=0, ii) X1=0 & MG1's MGTA=0.5 ms & MG2's MGTA=0.5 ms, iii)=0.5 ms & MG1's MGTA=0 and MG2's MGTA=0.5 ms or iv) X1=0.5 ms & MG1's MGTA=0.5 ms and MG2's MGTA=0, the total sum of interrupted slots by MG1 MGL and MG2 MGL may be 1 slot smaller than the sum of individual interrupted slots.

In case that UE capable of per-FR measurement gap is configured with per-FR measurement gap for FR2 serving cells, total number of interrupted slots on FR2 serving cells during MGL is listed in Table 13.

Table 13 shows total number of interrupted slots on FR2 serving cells during MGL for EN-DC, NR standalone operation (with single carrier, NR CA and NR-DC configuration) and NE-DC with per-UE measurement gap or per-FR measurement gap for FR2.

TABLE 13

| | Total number of interrupted slots on FR2 serving cells | | | | | | | | | |
|---|---|---|---|---|---|---|---|---|---|---|
| | When MG timing advance | | | | | When MG timing advance | | | | |
| NR | of 0 ms is applied | | | | | of 0.25 ms is applied | | | | |
| SCS | MGL = | MGL = | MGL = | MGL = | MGL = | MGL = | MGL = | MGL = | MGL = | MGL = |
| (kHz) | 20 ms | 10 ms | 5.5 ms | 3.5 ms | 1.5 ms | 20 ms | 10 ms | 5.5 ms | 3.5 ms | 1.5 ms |
| 60 | 80 | 40 | 22 | 14 | 6 | 80 | 40 | 22 | 14 | 6 |
| 120 | 160 | 80 | 44 | 28 | 12 | 160 | 80 | 44 | 28 | 12 |

NOTE 1:
The total number of interrupted slots is based on that SFN and subframe reference for per-FR gap in FR2 indicated by high layer parameter refServCellIndicator is an FR2 serving cell.
NOTE 2:
Slot occurs before or after the measurement gap may be interrupted additionally if SFN and subframe reference for per-FR gap in FR2 indicated by high layer parameter refServCelllndicator is an FR1 serving cell.

The number of interrupted slots set in Table 13 may be applied to MG1 MGL and MG2 MGL, respectively.

2. Fully-Overlapped (FO)

Which MG to be used in UE may be needed to be indicated.

If MGs are fully overlapped as FIGS. 9 (b) and (c), either MG1 or MG2 may be used in UE side. It needs to be indicated to UE which MG should be used. Network may decide which MG is used, considering priority of measurement. Depending on indicated MG, total number of effectively interrupted slots may need to be defined. For example, in FIG. 9 (c), if MG2 is MG with higher priority on measurement, the UE may perform measurement using MG2. After measurement with MG2 during MGL of MG2, the UE may not be expected to perform measurement using MG1 even though partial MGL of MG1 is remained. In other words, after the measurement based on MG2, the UE may be required to conduct data reception/transmission. Therefore, in this case, the total number of effectively interrupted slots on serving cell(s) may be specified based on the MG2.

3. Fully-Partial Overlapped (FPO)

In case that MGs are fully partially overlapped as FIG. 9 (d), either MG1 or MG2 may be also used in UE side. It may be indicated to UE which MG should be used. It may be decided from Network considering priority of measurement. It may be same story with FO.

4. Partially-Full Overlapped (PFO)

It may be same story with FO (FIG. 9 (c)) for duration of overlapping with MG1 and MG2.

5. Partially-Partial Overlapped (PPO)

It may be same story with FPO for duration of overlapping with MG1 and MG2.

A priority of configured MG in multiple MG patterns may be defined.

Measurement purpose of multiple MG patterns may be defined.

Priorities of configured multiple MG patterns may be indicated by network. It may be useful for UE to select MG in case of FO, FPO, PFO and PPO other than FNO.

Priorities of configured multiple MG patterns may be indicated in case of FO, FPO, PFO and PPO other than FNO. It may be useful for UE to select MG in the cases.

UE may perform measurement with higher priority of MG in duration of overlapping multiple MGs (FO, FPO, PFO and PPO other than FNO).

Total number of effectively interrupted slots on serving cell(s) may be defined, based on priority of MG in duration of overlapping multiple MGs (FO, FPO, PFO and PPO other than FNO).

According to this specification, MeasGapConfig information element in the table 6 above is changed as table 14.

TABLE 14
MeasGapConfig
information element

| | | | |
|---|---|---|---|
| MeasGapConfig | gapFR2 | SetupRelease | OPTIONAL |
| | | {GapConfig} | |
| | gapFR1 | SetupRelease | OPTIONAL |
| | | {GapConfig} | |
| | gapUE | SetupRelease | OPTIONAL |
| | | {GapConfig} | |
| | gapUEToAddModList-r17 | SEQUENCE (SIZE | OPTIONAL |
| | | (1 . . . maxNrofGapId-1-r17)) | |
| | | OF GapConfig | |
| | gapUEToReleaseList-r17 | SEQUENCE (SIZE | OPTIONAL |
| | | (1 . . . maxNrofGapId-1-rl7)) | |
| | | OF MeasGapId-r17 | |
| | gapFR1ToAddModList-r17 | SEQUENCE (SIZE | OPTIONAL |
| | | (1 . . . maxNrofGapId-1-r17)) | |
| | | OF GapConfig | |
| | gapFR1ToReleaseList-r17 | SEQUENCE (SIZE | OPTIONAL |
| | | (1 . . . maxNrofGapId-1-r17)) | |
| | | OF MeasGapId-r17 | |
| | gapFR2ToAddModList-r17 | SEQUENCE (SIZE | OPTIONAL |
| | | (1 . . . maxNrofGapId-1-r17)) | |
| | | OF GapConfig | |
| | gapFR2ToReleaseList-r17 | SEQUENCE (SIZE | OPTIONAL |
| | | (1 . . . maxNrofGapId-1-r17)) | |
| | | OF MeasGapId-r17 | |
| GapConfig. | gapOffset | INTEGER (0 . . . 159) | |
| | mgl | ENUMERATED {ms1dot5, | |
| | | ms3, ms3dot5, ms4, | |
| | | ms5dot5, ms6} | |
| | mgrp | ENUMERATED {ms20, | |
| | | ms40, ms80, ms160} | |
| | mgta | ENUMERATED {ms0, | |
| | | ms0dot25, ms0dot5} | |
| | refServCellIndicator | ENUMERATED {pCell, | OPTIONAL |
| | | pSCell, mcg-FR2} | |
| | refFR2ServCellAsyncCA-r16 | ServCellIndex | OPTIONAL |
| | mgl-r16 | ENUMERATED {ms10, | OPTIONAL |
| | | ms20} | |
| | measGapId-r17 | MeasGapId-r17 | OPTIONAL |
| | preConfigInd-r17 | ENUMERATED {true} | OPTIONAL |
| | nscgInd-r17 | ENUMERATED {true} | OPTIONAL |
| | mgta-r17 | ENUMERATED | OPTIONAL |
| | | {ms0dot75} | |
| | mgl-r17 | ENUMERATED {ms1, | OPTIONAL |
| | | ms2, ms5} | |
| | gapAssociationPRS-r17 | ENUMERATED {true} | OPTIONAL |
| | gapSharing-r17 | MeasGapSharingScheme | OPTIONAL |
| | gapPriority-r17 | GapPriority-r17 | OPTIONAL |

That is, MeasGapConfig information element includes gapPriority-r17 related to priority of MG. Therefore, although multiple MGs are overlapped each other, UE may perform measurement based on the priority.

6. Overhead Issue

Desirable, it may be expected there is no significant performance degradation of serving cell(s) by multiple MG patterns.

If multiple MG patterns are applied to UE, the UE may not be required to transmit or receive data during MGL of the multiple MGs. It may mean performance degradation can occur higher than a single MG pattern. The performance degradation may be simply calculated with sum of ratio of MGL/MGRP from configuration of each MG pattern ID.

For example, multiple MG patterns may be configured with MG ID #0 and MG ID #1, performance degradation may be about 22.5% and it may be 7.5% higher than that of single MG ID #0. Instead of MG ID #1, using MG ID #5, performance degradation may be about 18.75%. It is 3.75% higher than that of single MG ID #0.

One way to define an overhead cap may be to set the increased ratio is less than the threshold (K) comparing with the legacy single MG or referenced single MG.

$${\sum }_{m = 1}^{N} ( \frac{{MGL}_{m}}{{MGRP}_{m}} ) / ( \frac{{MGL}_{r}}{{MGRP}_{r}} ) \leq 1 + threshold \qquad [ equation 1 ]$$

N may be number of multiple MG patterns. MGLr may be MGL of referenced MG. MGRPr may be MGRP of reference MG.

For example, threshold (K) may be recommended with 5%.

When configuring multiple MG patterns, overhead cap with threshold of

$${\sum }_{m = 1}^{N} ( \frac{{MGL}_{m}}{{MGRP}_{m}} ) / ( \frac{{MGL}_{r}}{{MGRP}_{r}} )$$

may be defined as

$$‘ {\sum }_{m = 1}^{N} ( \frac{{MGL}_{m}}{{MGRP}_{m}} ) / ( \frac{{MGL}_{r}}{{MGRP}_{r}} ) \leq 1 + threshold ’ .$$

N may be number of multiple MG patterns. MGLr may be reference of MGL or MGL of referenced MG. MGRPr may be reference of MGRP or MGRP of reference MG.

M may include r.

MGLr and MGRPr may be designated as one of the Gap pattern IDs of table 15.

MGLr and MGRpr may be distinguished and assigned according to per-UE multiple MG and per-FR multiple MG.

For example,
In the case of Per-UE multiple MG, among Gap Pattern IDs #0 to #11, MGLr/MGRPr may be the largest Gap Pattern ID #0. MGLr may be 6. MGRpr may be 40.
In case of Per-FR multiple MG, FR1 multiple MG may be Gap Pattern ID #0 which is the largest MGLr/MGRPr among Gap Pattern ID #0˜#11. FR2 multiple MG may be Gap Pattern ID #12 which is the largest MGLr/MGRPr among Gap Pattern ID #12˜ Among #23. MGLr may be 6 for FR1. MGRpr may be 40 for FR1. MGLr may be 5.5 for FR2. MGRPR may be 20 for FR2.

Table 15 shows Gap Pattern Configurations.

TABLE 15

| Gap | Measurement | Measurement Gap |
|---|---|---|
| Pattern | Gap Length | Repetition Period |
| Id | (MGL, ms) | (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |
| 24 | 10 | 80 |
| 25 | 20 | 160 |

Reference of MGLr and MGRPr, or reference of MG may be defined.

Multiple MG patterns considering the overhead cap may be configured.

7. Additional Embodiment

For FO, FPO, PFO and PPO, some options may be listed for gap collision handling.

One of overlapping issues may be rule for colliding gap occasions, if one of FO, FPO, PFO, PPO cases is introduced (Agreement).

A general rule for UE from the following aspects may be defined.

Gap collision handling on UE's measurement behavior if it is agreed to define the requirements for any or all of the FO/FPO/PFO/PPO/FNO cases may be defined as following options.
Option 1: A sharing factor between 2 gaps may be defined, e.g., given X % gap sharing, the measurement with regard to one gap may share roughly X % of the time, while the other gap may share the remaining
Option 2: Priority may be considered when measuring only in one MG in occasions where the two MGs are overlapped. Gap sharing may be considered if each priority for two MGs is same
Option 3: Only priority rule, e.g., UE may only do the measurement with regard to the gap with higher priority on all colliding occasions.
Option 4: Per-UE MG may take higher priority than per-FR MG for case2 when two MGs of different types overlap.
Option 5: A priority pattern to indicate which gap will be prioritized within the collision gap instance once proximity condition is met may be defined, e.g., NW (network) may indicate the priority pattern based on the LCM of two gaps' MGRPs. The data scheduling may be expected during the dropped gap instance.
Other options may not be precluded

The proximity conditions to apply gap collision handling, e.g., a time domain minimal distance Mims between the two gap instances may be FFS whether the same gap collision handling can be applied to all of the FO/FPO/PFO/PPO/FNO cases.

UE's measurement behavior may be focused. The scheduling opportunity (i.e., gap interruption) will be discussed in a separate issue

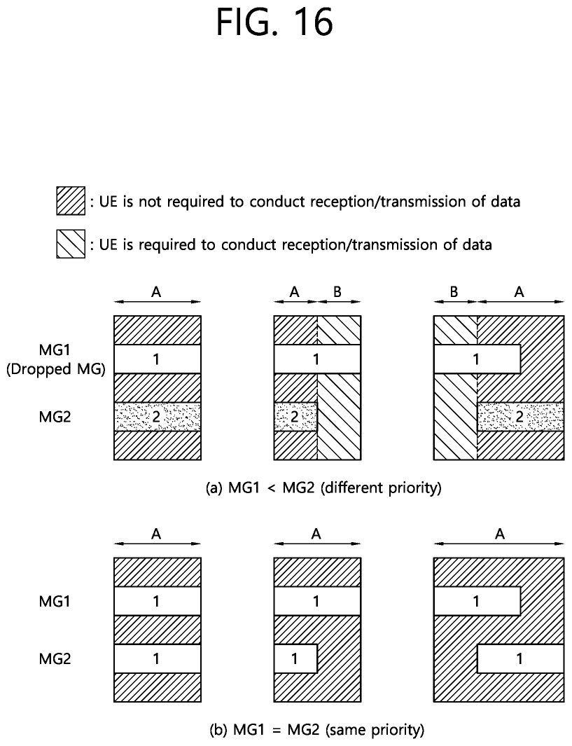

FIG. 16 shows overlapping MGs with different/same priority.

FIG. 16 (a) shows the corresponding example. MG2 has a higher priority than MG1. In that case, MG1 may be dropped. As a result, UE may not be required to conduct reception or transmission of data during the duration of A but may be required to conduct reception or transmission of data during the duration of B. The duration A is MGL of MG2. The duration B is non-overlapped MGL of MG1 from MGL of MG2.

If priority is same, the gap sharing rule may be applied. For gap sharing, a network cannot know which MG among the configured multiple MGs is used in UE side. FIG. 16 (b) shows the corresponding example. In that case, UE may not be required to conduct reception or transmission of data during the duration of A. The duration A may be an entire MGL of both MG1 and MG2.

If the MGs are overlapped, and each MGRP is same, and different priorities are configured with constant value and is not deactivated, then there may be no chance to measure for lower priority MG.

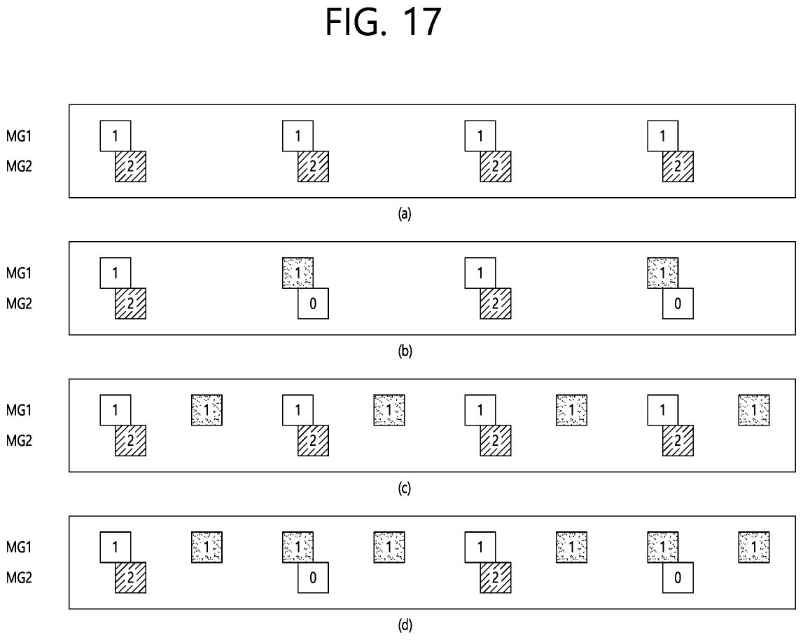

FIG. 17 shows measurement of overlapped MGs with different priority.

FIG. 17 (a) shows this example. The priority may be assumed to be configured with ‘1’ for MG1 and ‘2’ for MG2. In the case, there may no measurement to be expected with MG1. It may be problematic. To solve it, MG2 may be configured with some pattern with lower priority and higher priority than MG1.

FIG. 17 (b), the priority of MG2 may be configured with ‘2’ and ‘0’. In the case, UE may measure with both MG1 and MG2.

FIG. 17 (c) and FIG. 17 (d) show the case of different MGRP.

FIG. 17 (c), the priority may be assumed to be configured with ‘1’ for MG1 and ‘2’ for MG2. In the case, there may no measurement to be expected with MG1 during overlapped duration. However, it is not problematic, because the measurement can be expected with MG1 during non-overlapped duration.

Priority on the MGs when measuring only in one MG in occasions where the two MGs are overlapped may be defined.

Gap sharing may be used if each priority for two MGs is same.

Priority not to exclude any overlapped MG during all overlapped durations may be configured.

1) Method 1

In multiple MGs, based on the legacy MG, the priority of the newly authorized MG may be set as a combination of a larger value and a smaller value than the priority of the legacy MG. The NW and the UE may share time information about the actually applied priority. In this case, when multiple MGs are partially overlapped, data scheduling may be possible in the remaining MGL of the lower MG located outside the MGL of the actually used MG (FIG. 16 (a)). In FIG. 16 (a), NW and the UE may perform data reception or transmission in duration of B.

2) Method 2

In multiple MGs, it may be proposed to set the priority for the MG to a temporally variable value rather than a fixed value. At this time, considering the gap sharing factor, it may be proposed to determine the priority so that the gap sharing factor of the MG to be actually used can be reflected in the actual overlapping part. For example, a value used for the gap sharing factor may be ‘0, 25, 50, 75, 100’. For example, if the gap sharing factor is 25, it may mean that 25% of the corresponding MG is used in the overlapping part. If it is ‘100’, it is 100% used, if it is ‘0’, it is 0% used, which may mean that 100% of other MG is used. A method of setting a priority pattern for each MG may be also proposed as an example. It may be proposed that the NW and the UE share time information about the actually applied priority. In this case, when multiple MGs are partially overlapped, data scheduling may be possible in the remaining MGL of the lower MG located outside the MGL of the actually used MG (FIG. 16 (a)).

UE may not be required to conduct reception/transmission of data during MGL of MG with high priority if priority between MGs is different in case of overlapped MGs.

UE may be required to conduct reception/transmission of data during outside of MGL of MG with high priority if priority between MGs is different in case of overlapped MGs.

UE may not be required to conduct reception/transmission of data during entire MGLs of multiple MGs if priority between MGs is same in case of overlapped MGs.

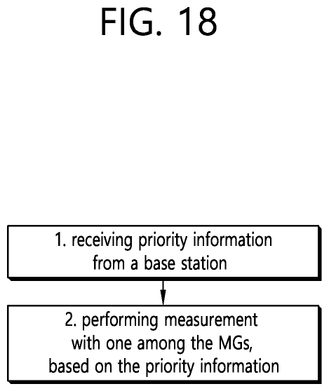

FIG. 18 shows a procedure of UE according to the disclosure of the present specification.

The UE may receive priority information from a base station.

The priority information may include each priority of MGs (Measurement Gaps).

The UE may perform measurement with one among the MGs, based on the priority information.

The one among the MGs may be overlapped with the other MGs in time domain,

The one among the MGs may have higher priority than the other MGs.

The UE may drop measurement of the other MGs.

The UE may perform data reception of transmission in a slot which are not overlapped with the one in the other MGs.

Hereinafter, a device configured to operate in a wireless system, according to some embodiments of the present disclosure, will be described.

For example, a terminal may include a processor, a transceiver, and a memory.

For example, the processor may be configured to be coupled operably with the memory and the processor.

The processor may be configured to receive priority information from a base station, wherein the priority information includes each priority of MGs (Measurement Gaps); perform measurement with one among the MGs, based on the priority information, wherein the one among the MGs is overlapped with the other MGs in time domain, wherein the one among the MGs has higher priority than the other MGs.

Hereinafter, a processor in a wireless communication system, according to some embodiments of the present disclosure, will be described.

The processor may be configured to control the transceiver to receive priority information from a base station, wherein the priority information includes each priority of MGs (Measurement Gaps); perform measurement with one among the MGs, based on the priority information, wherein the one among the MGs is overlapped with the other MGs in time domain, wherein the one among the MGs has higher priority than the other MGs.

Hereinafter, a non-transitory computer-readable medium has stored thereon a plurality of instructions in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a base station.

The stored a plurality of instructions may cause the terminal to receive priority information from a base station, wherein the priority information includes each priority of MGs (Measurement Gaps); perform measurement with one among the MGs, based on the priority information, wherein the one among the MGs is overlapped with the other MGs in time domain, wherein the one among the MGs has higher priority than the other MGs.

The present disclosure can have various advantageous effects.

For example, by configuring priorities of MGs, in cased MGs are overlapped, UE can select one of the MGs and perform measurement with the one.

Advantageous effects obtained through specific examples of the present specification are not limited to the effects listed above. For example, there may be a variety of technical effects that a person having ordinary skill in the related art can understand or derive from this specification. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

What is claimed is:

1. A method for performing measurement, by performed a UE (User Equipment), comprising:
receiving priority information from a base station,
wherein the priority information includes each priority of MGs (Measurement Gaps);
performing measurement with one among the MGs, based on the priority information,
wherein the one among the MGs is overlapped with the other MGs in time domain,
wherein the one among the MGs has higher priority than the other MGs.

2. The method of claim 1, further comprising:
dropping measurement of the other MGs.

3. The method of claim 1, further comprising:
performing data reception of transmission in a slot which are not overlapped with the one in the other MGs.

4. A device configured to operate in a wireless system, the device comprising:
a transceiver,
a processor operably connectable to the transceiver,
wherein the processer is configured to:
receive priority information from a base station,
wherein the priority information includes each priority of MGs (Measurement Gaps);
perform measurement with one among the MGs, based on the priority information,
wherein the one among the MGs is overlapped with the other MGs in time domain,
wherein the one among the MGs has higher priority than the other MGs.

5. The device of claim 4,
wherein the processer is configured to drop measurement of the other MGs.

6. The device of claim 4,
wherein the processer is configured to perform data reception of transmission in a slot which are not overlapped with the one in the other MGs.

7. At least one computer readable medium (CRM) storing instructions that, based on being executed by at least one processor, perform operations comprising:
receiving priority information from a base station,
wherein the priority information includes each priority of MGs (Measurement Gaps);
performing measurement with one among the MGs, based on the priority information,
wherein the one among the MGs is overlapped with the other MGs in time domain,
wherein the one among the MGs has higher priority than the other MGs.
